(19) United States
(12) Patent Application Publication
(10) Pub. No.: US 2021/0158560 A1
(43) Pub. Date: May 27, 2021

(54) METHOD AND DEVICE FOR OBTAINING LOCALIZATION INFORMATION AND STORAGE MEDIUM

(71) Applicant: Beijing Xiaomi Mobile Software Co., Ltd., Beijing (CN)

(72) Inventor: Yutong Zang, Beijing (CN)

(73) Assignee: Beijing Xiaomi Mobile Software Co., Ltd.

(21) Appl. No.: 16/834,194

(22) Filed: Mar. 30, 2020

(30) Foreign Application Priority Data
Nov. 22, 2019 (CN) 201911158676.2

(51) Int. Cl. G06T 7/70; G06T 7/50

(52) U.S. Cl. CPC G06T 7/70; G06T 2207/10028; G06T 7/50

(57) ABSTRACT

A method for obtaining localization information, includes: obtaining image information and related information of the image information, wherein the related information includes a depth map, a point cloud map, and relocation postures and relocation variance after relocation; obtaining three-dimensional coordinates of spatial obstacle points based on the depth map; obtaining target postures and environmental three-dimensional coordinates corresponding to each of the target postures based on the relocation postures, the relocation variance, and the point cloud map; scanning and matching the three-dimensional coordinates of the spatial obstacle points with the environmental three-dimensional coordinates to obtain matching result information; and obtaining localization information based on the relocation postures and the relocation variance when the matching result information satisfies a predetermined condition.

### CROSS-REFERENCE TO RELATED APPLICATION

The present application is based upon and claims priority to Chinese Patent Application No. 201911158676.2 filed on Nov. 22, 2019, the content of which is hereby incorporated by reference in its entirety.

### TECHNICAL FIELD

The present disclosure relates to the field of visual localization technology, and particularly to a method and device for obtaining localization information, and a storage medium.

### BACKGROUND

Visual localization technology refers to accomplishment of localization tasks through machine vision, which is a research hotspot in the fields of augmented reality (AR) technology and mobile robots in recent years. On the one hand, mobile phone manufacturers realize AR functions in some mobile phones by using cameras of the mobile phones and visual localization algorithms, but due to the limited accuracy of the existing localization technologies, AR applications in the mobile phones are restricted, and thus mobile phone manufacturers are committed to the research of visual localization. On the other hand, due to advantages of machine vision with respect to traditional laser sensors, mobile robot companies are also investing in the research and development of visual localization in order to solve existing problems.

### SUMMARY

According to a first aspect of embodiments of the present disclosure, a method for obtaining localization information includes: obtaining image information and related information of the image information, wherein the related information includes: a depth map, a point cloud map, and relocation postures and relocation variance after relocation; obtaining three-dimensional coordinates of spatial obstacle points based on the depth map; obtaining target postures and environmental three-dimensional coordinates corresponding to each of the target postures based on the relocation postures, the relocation variance, and the point cloud map; scanning and matching the three-dimensional coordinates of the spatial obstacle points with the environmental three-dimensional coordinates to obtain matching result information; and obtaining localization information based on the relocation postures and the relocation variance when the matching result information satisfies a predetermined condition.

According to a second aspect of the embodiments of the present disclosure, a device for obtaining localization information includes: a processor; and a memory for storing instructions executable by the processor; wherein the processor is configured to: obtain image information and related information of the image information, wherein the related information includes a depth map, a point cloud map, and relocation postures and relocation variance after relocation; obtain three-dimensional coordinates of spatial obstacle points based on the depth map; obtain target postures and environmental three-dimensional coordinates corresponding to each of the target postures based on the relocation postures, the relocation variance, and the point cloud map; scan and match the three-dimensional coordinates of the spatial obstacle points with the environmental three-dimensional coordinates to obtain matching result information; and obtain localization information based on the relocation postures and the relocation variance when the matching result information satisfies a predetermined condition.

According to a third aspect of the embodiments of the present disclosure, a non-transitory computer-readable storage medium has stored thereon instructions that, when executed by a processor of a terminal, cause the terminal to implement a method for obtaining localization information. The method includes: obtaining image information and related information of the image information, wherein the related information includes a depth map, a point cloud map, and relocation postures and relocation variance after relocation; obtaining three-dimensional coordinates of spatial obstacle points based on the depth map; obtaining target postures and environmental three-dimensional coordinates corresponding to each of the target postures based on the relocation postures, the relocation variance, and the point cloud map; scanning and matching the three-dimensional coordinates of the spatial obstacle points with the environmental three-dimensional coordinates to obtain matching result information; and obtaining localization information based on the relocation postures and the relocation variance when the matching result information satisfies a predetermined condition.

It is to be understood that the above general description and the following detailed description below are merely exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the present disclosure.

FIG. 1 is a schematic diagram of a relocation process in existing visual localization.

FIG. 2 is a flowchart illustrating a method for obtaining localization information according to an exemplary embodiment of the disclosure.

FIG. 3 is a flowchart illustrating the operations of obtaining target postures and environmental three-dimensional coordinates corresponding to each of the target postures based on relocation postures, a relocation variance, and a point cloud map according to an exemplary embodiment of the disclosure.

FIG. 4 is a flowchart illustrating the operations of obtaining target postures and environmental three-dimensional coordinates corresponding to each of the target postures based on relocation postures, a relocation variance and a point cloud map according to an exemplary embodiment of the disclosure.

FIG. 5 is a flowchart illustrating the operations of scanning and matching three-dimensional coordinates of spatial obstacle points with environmental three-dimensional coordinates to obtain matching result information and obtaining localization information based on relocation postures and a relocation variance when the matching result information satisfies a predetermined condition, according to an exemplary embodiment of the disclosure.

FIG. 6 is a flowchart illustrating the operations of obtaining a matching score of each particle by scanning and matching three-dimensional coordinates of spatial obstacle points with environmental three-dimensional coordinates of each particle according to an exemplary embodiment of the disclosure.

FIG. 7 is a flowchart illustrating a method for obtaining localization information according to an exemplary embodiment of the disclosure.

FIG. 8 is a block diagram illustrating a device for obtaining localization information according to an exemplary embodiment of the disclosure.

FIG. 9 is a block diagram illustrating a device according to an exemplary embodiment of the disclosure.

FIG. 10 is a block diagram of a device according to an exemplary embodiment of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

At present, there are several visual localization technologies. For illustrative purpose only, the present disclosure will be described by taking visual simultaneous localization and mapping (SLAM) technology as an example.

From the perspective of visual sensors, visual SLAM mainly includes monocular+IMU SLAM, binocular SLAM and RGBD-SLAM. These three types of visual SLAM have different three-dimensional visual calculation methods, but due to requirements of the visual SLAM, the framework components of the whole visual SLAM are basically the same, including front-end optimization and back-end optimization, which are divided into four main modules: a localization module, a mapping module, a relocation module and a closed-loop module. These four modules are used to accomplish the tasks of SLAM. As a method for correcting localization errors in a visual system, the relocation module is configured to improve the robustness of the visual localization system. However, in the navigation and localization of many actual scenes, a traditional relocation algorithm may fail due to the similar distribution of feature points in the visual system, which may not correct the wrong localization, and may also easily lead to the wrong localization. Once the wrong localization occurs, the entire existing visual SLAM system may fail.

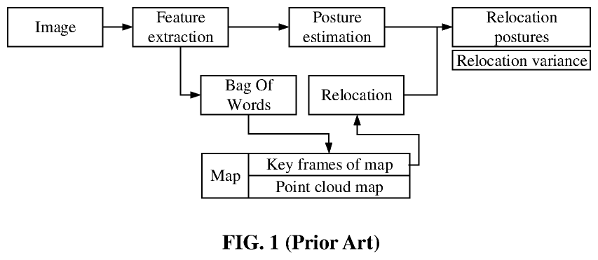

FIG. 1 illustrates a schematic diagram of a relocation process in the existing visual localization. In FIG. 1, a relocation module takes image features as an input, outputs postures after relocation and optimizes posture estimation of the system.

The relocation module is introduced in order to solve the problem of cumulative error of posture estimation. However, due to the complex scenes in reality, the algorithm, such as the Bag Of Words model, and the heuristic selection rule for key frames adopted by the relocation module may be difficult to ensure that the key frames have a good distribution in space while all the key-frame feature vectors have strong discrimination. This may result in a probability that the relocation module gives a wrong posture in practice, which will lead to the localization error, and further, this error may not be eliminated by the visual SLAM system itself until the next correct relocation, which leads to the localization error of the visual SLAM.

The present disclosure provides a method for obtaining localization information. On the basis of the existing visual localization system, a processing module, parallel with the relocation module, is added to determine whether an output posture of the relocation module is correct, so as to improve the robustness of the visual localization.

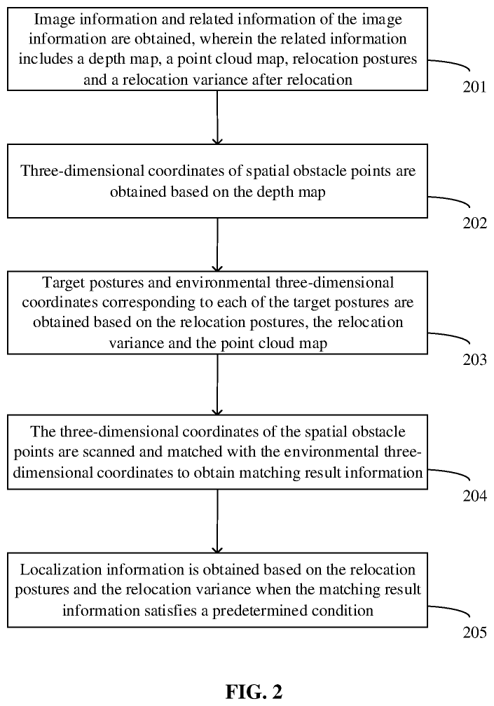

FIG. 2 is a flowchart of a method for obtaining localization information according to an exemplary embodiment. As illustrated in FIG. 2, the method includes the following operations.

In operation 201, image information and related information of the image information are obtained, wherein the related information includes a depth map, a point cloud map, relocation postures and a relocation variance after relocation.

In operation 202, three-dimensional coordinates of spatial obstacle points are obtained based on the depth map.

In operation 203, target postures and environmental three-dimensional coordinates corresponding to each of the target postures are obtained based on the relocation postures, the relocation variance and the point cloud map.

In operation 204, the three-dimensional coordinates of the spatial obstacle points are scanned and matched with the environmental three-dimensional coordinates to obtain matching result information.

In operation 205, localization information is obtained based on the relocation postures and the relocation variance when the matching result information satisfies a predetermined condition.

In an embodiment, in operation 201, the image information during localization illustrated in FIG. 1 is obtained. The image information may be a frame of image. The point cloud map is obtained by processing the frame of image, and relocation postures and relocation variance corresponding to the relocation postures are obtained based on relocation of the frame of image. The point cloud map, the relocation postures and the relocation variance are illustrated in FIG. 1. In addition, the depth map obtained corresponds to the frame of image, that is, the frame of image and its corresponding depth map are both taken at the same time for the same scene.

In an embodiment, the depth map may be a dense depth map. The binocular visual device and the RGBD visual device can directly output the dense depth map information. The monocular+IMU visual device can process a sparse depth map to obtain the dense depth map.

In an embodiment, in operation 202, the three-dimensional coordinates of spatial obstacle points obtained based on the depth map may also be calculated by a camera formula known to those skilled in the art.

In an embodiment, in operation 203, the obtaining target postures and environmental three-dimensional coordinates corresponding to each of the target postures based on the relocation postures, the relocation variance and the point cloud map includes: obtaining the target postures based on the relocation postures and the relocation variance, wherein the target postures are represented by particles, and obtaining the environmental three-dimensional coordinates corresponding to the target postures through the particles and the point cloud map, which will be further described below.

In an embodiment, in operations 204 and 205, the environmental three-dimensional coordinates corresponding to each of the target postures are matched with the three-dimensional coordinates of spatial obstacle points by a manner of scan matching, and a matching score is calculated. The highest matching score is determined from the matching scores of these target postures. In this case, the matching result information may be a matching score of each target posture, and the predetermined condition may be the condition whether the highest matching score exceeds a predetermined threshold. The predetermined threshold may be preset by a user or obtained in advance through offline experiments according to a specific application scene, which is not limited in the disclosure. If the highest matching score meets the requirement of exceeding the predetermined threshold, it is determined that the relocation posture is correct. If the highest matching score does not meet the threshold requirement, it is determined that the relocation posture is wrong, and the result of the relocation is not used.

The above method can improve accuracy of output postures of the relocation, such that the problem of the wrong posture result given by the relocation module is solved, thereby improving the robustness of the visual localization.

FIG. 3 is a flowchart illustrating the operation 203 (FIG. 2) of obtaining target postures and environmental three-dimensional coordinates corresponding to each of the target postures based on the relocation postures, the relocation variance and the point cloud map. As illustrated in FIG. 3, the operation in 203 of FIG. 2 may further include the following operations.

In operation 301, a particle set is obtained based on the relocation postures and the relocation variance, wherein each particle in the particle set corresponds to one of the target postures.

In operation 302, environmental three-dimensional coordinates of each particle is obtained based on the point cloud map, wherein the environmental three-dimensional coordinates corresponding to each of the target postures are environmental three-dimensional coordinates of the particle corresponding to the target posture.

In an embodiment, in operation 301, the obtaining the particle set based on the relocation postures and the relocation variance may use the method of constructing Gaussian probability distribution, Kalman filter or Bayesian estimation.

In an embodiment, in operation 302, the environmental three-dimensional coordinates of each particle are coordinates of the point cloud map projected into the coordinate system corresponding to each target posture (particle).

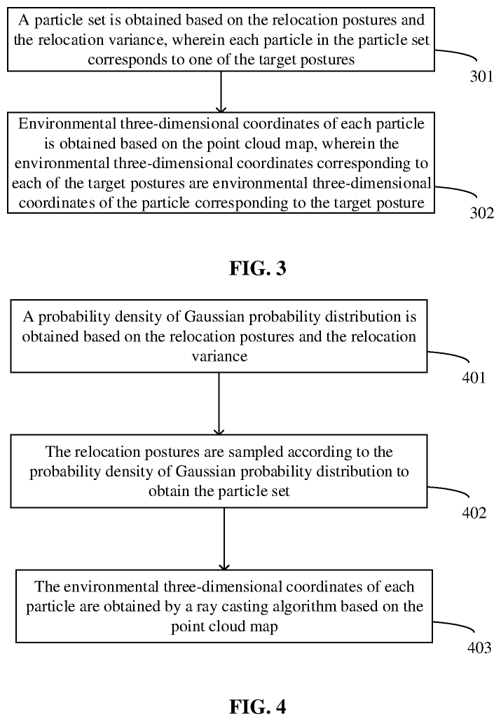

FIG. 4 is a flowchart illustrating the operation 203 (FIG. 2) of obtaining target postures and environmental three-dimensional coordinates corresponding to each of the target postures based on the relocation postures, the relocation variance and the point cloud map, according to an exemplary embodiment. As illustrated in FIG. 4, the operation 203 of FIG. 2 may further include the following operations.

In operation 401, a probability density of Gaussian probability distribution is obtained based on the relocation postures and the relocation variance.

In operation 402, the relocation postures are sampled according to the probability density of Gaussian probability distribution to obtain the particle set.

In operation 403, the environmental three-dimensional coordinates of each particle are obtained by a ray casting algorithm based on the point cloud map.

In an embodiment, operations 401 and 402 correspond to operation 301 (FIG. 3), and operation 403 corresponds to operation 302 (FIG. 3).

In an embodiment, in operations 401 and 402, the target postures are obtained through the probability density of Gaussian probability distribution, i.e., the particle set is obtained. The Gaussian probability distribution is used here because the Gaussian distribution has a faster calculation speed without dealing with complex Jacobian matrix operations and is also easy to model.

In an embodiment, in operation 403, the point cloud map and each particle are used to calculate the environmental three-dimensional coordinates of the corresponding particle by the ray casting algorithm, which is known to those skilled in the art.

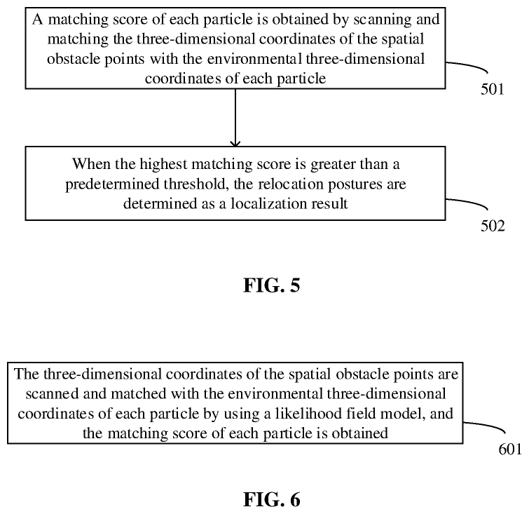

FIG. 5 is a flowchart illustrating the operations 204 and 205 (FIG. 2) of scanning and matching the three-dimensional coordinates of the spatial obstacle points with the environmental three-dimensional coordinates to obtain matching result information and obtaining localization information based on the relocation postures and the relocation variance when the matching result information satisfies a predetermined condition. As illustrated in FIG. 5, the operations in 204 and 205 of FIG. 2 may further include the following operations.

In operation 501, a matching score of each particle is obtained by scanning and matching the three-dimensional coordinates of the spatial obstacle points with the environmental three-dimensional coordinates of each particle.

In operation 502, when the highest matching score is greater than a predetermined threshold, the relocation postures are determined as a localization result.

In this embodiment, the environmental three-dimensional coordinates of each particle are environmental three-dimensional coordinates of the target posture corresponding to the particle obtained based on the point cloud map, and the matching score of each particle may be obtained by scanning and matching these two kinds of three-dimensional coordinates. If the matching score of any particle is greater than a predetermined threshold, it is determined that the relocation posture is correct. Therefore, the highest matching score is selected to determine whether the highest matching score is greater than a predetermined threshold. The predetermined threshold may be obtained in advance through offline experiments according to a specific application scene. In another example, the predetermined threshold may be preset by a user.

FIG. 6 is a flowchart illustrating the operation 501 (FIG. 5) of obtaining a matching score of each particle by scanning and matching the three-dimensional coordinates of the spatial obstacle points with the environmental three-dimensional coordinates of each particle. As illustrated in FIG. 6, the operation in 501 of FIG. 5 may further include the following operation.

In operation 601, the three-dimensional coordinates of the spatial obstacle points are scanned and matched with the environmental three-dimensional coordinates of each particle by using a likelihood field model, and the matching score of each particle is obtained.

When the scan matching algorithm is performed, the matching scores of the particles are calculated by using a likelihood field model. The matching algorithm and the likelihood field model may be those known to one skilled in the art.

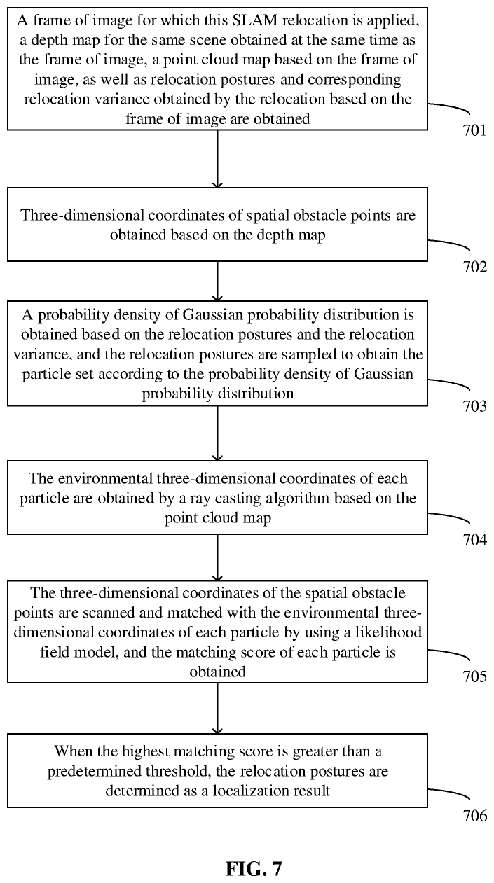

FIG. 7 illustrates is a flowchart of a method for obtaining localization information according to an exemplary embodiment. In the embodiment, the localization information is obtained based on the result of SLAM relocation. The method includes the following operations.

In operation 701, a frame of image to which SLAM relocation is applied, a depth map for a same scene obtained at a same time as the frame of image, a point cloud map based on the frame of image, as well as relocation postures and corresponding relocation variance obtained by the relocation based on the frame of image are obtained.

In operation 702, three-dimensional coordinates of spatial obstacle points are obtained based on the depth map.

In operation 703, a probability density of Gaussian probability distribution is obtained based on the relocation postures and the relocation variance, and the relocation postures are sampled to obtain the particle set according to the probability density of Gaussian probability distribution.

In operation 704, the environmental three-dimensional coordinates of each particle are obtained by a ray casting algorithm based on the point cloud map.

In operation 705, the three-dimensional coordinates of the spatial obstacle points are scanned and matched with the environmental three-dimensional coordinates of each particle by using a likelihood field model, and the matching score of each particle is obtained.

In operation 706, when the highest matching score is greater than a predetermined threshold, the relocation postures are determined as a localization result. When the highest matching score is less than or equal to the predetermined threshold, the relocation postures are not used.

In the embodiment, three-dimensional coordinates of spatial obstacle points are obtained based on the depth map, environmental three-dimensional coordinates corresponding to each of the estimated target postures are obtained based on the relocation postures, the relocation variance and the point cloud map, and the three-dimensional coordinates of the spatial obstacle points are scanned and matched with the environmental three-dimensional coordinates corresponding to each of the estimated target postures to determine whether the relocation postures are available, and then localization information is obtained.

In some embodiments, the above methods may be implemented by using an existing localization device, without the need of additional hardware sensing devices or changing the main structure of the visual localization system. Through the above methods, the problem of weak localization robustness caused by the high dependence of the relocation module on the visual algorithm in the existing visual localization system is solved, and the localization robustness is improved.

In some embodiments, additional sensors may be added to the visual localization system to perform the above methods, such as adding laser sensors for algorithm fusion, or using a coded disc installed on the robot body for algorithm fusion in the field of use of a ground mobile robot. However, adding external sensors may not have advantages in terms of cost, power consumption and size. The methods provided in the disclosure do not require adding additional hardware sensor devices, and can solve the problem of localization errors of the relocation module in the actual operation of the visual localization system by adding parallel modules, thereby improving the robustness of the visual localization system in the actual environment.

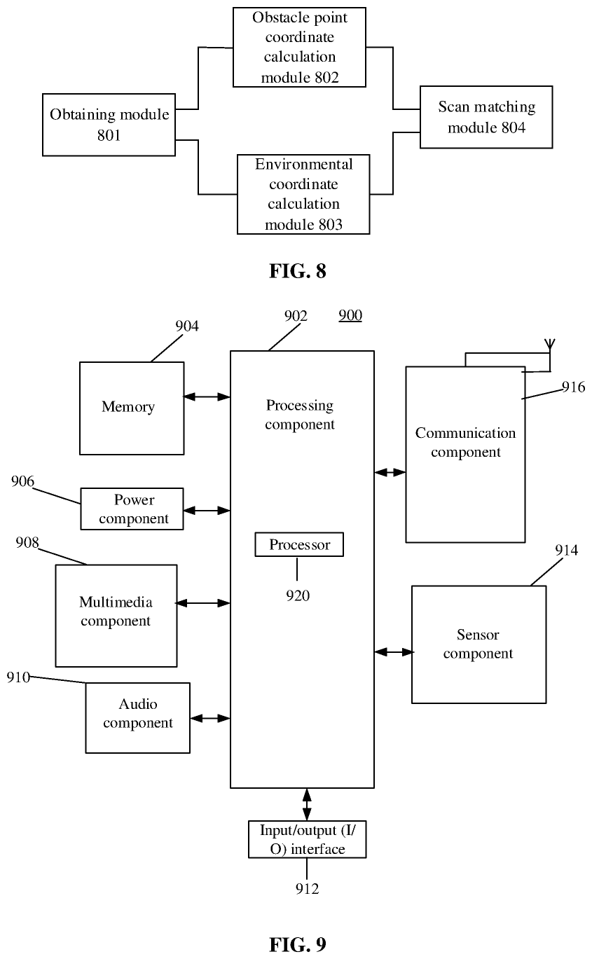

FIG. 8 illustrates is a block diagram of a device for obtaining localization information according to an exemplary embodiment. As illustrated as FIG. 8, the device includes an obtaining module 801, an obstacle point coordinate calculation module 802, an environmental coordinate calculation module 803, and a scan matching module 804.

The obtaining module 801 is configured to obtain image information and related information of the image information. The related information includes a depth map, a point cloud map, relocation postures and a relocation variance after the relocation.

The obstacle point coordinate calculation module 802 is configured to obtain three-dimensional coordinates of spatial obstacle points based on the depth map.

The environmental coordinate calculation module 803 is configured to obtain target postures and environmental three-dimensional coordinates corresponding to each of the target postures based on the relocation postures, the relocation variance and the point cloud map.

The scan matching module 804 is configured to scan and match the three-dimensional coordinates of the spatial obstacle points with the environmental three-dimensional coordinates to obtain matching result information, and obtain localization information based on the relocation postures and the relocation variance when the matching result information satisfies a predetermined condition.

In an embodiment, the environmental coordinate calculation module 803 is further configured to: obtain a particle set based on the relocation postures and the relocation variance, wherein each particle in the particle set corresponds to one of the target postures; and obtain environmental three-dimensional coordinates of each particle based on the point cloud map, wherein the environmental three-dimensional coordinates corresponding to each of the target postures are environmental three-dimensional coordinates of the particle corresponding to the target posture.

In an embodiment, the environmental coordinate calculation module 803 is further configured to: obtain a probability density of Gaussian probability distribution based on the relocation postures and the relocation variance; sample the relocation postures to obtain the particle set according to the probability density of Gaussian probability distribution; and obtain the environmental three-dimensional coordinates of each particle by a ray casting algorithm based on the point cloud map.

In an embodiment, the scan matching module 804 is further configured to: obtain a matching score of each particle by scanning and matching the three-dimensional coordinates of the spatial obstacle points with the environmental three-dimensional coordinates of each particle; and determine, when the highest matching score is greater than a predetermined threshold, the relocation postures as the localization result.

In an embodiment, the scan matching module 804 is further configured to: scan and match the three-dimensional coordinates of the spatial obstacle points with the environmental three-dimensional coordinates of each particle by using a likelihood field model, and obtain the matching score of each particle.

The various modules can be implemented using any suitable technology. For example, a module may be implemented using circuitry, such as an integrated circuit (IC). As another example, a module may be implemented as a processing circuit executing software instructions.

With respect to the device in the above embodiments, the specific manners in which the modules perform operations have been described in detail in the method embodiments, which will not be repeated herein.

The present disclosure also provides a device for obtaining localization information, which includes a processor and a memory for storing instructions executable by the processor. The processor is configured to perform any of the above described methods for obtaining localization information. In an embodiment, the processor may implement the functions of the obtaining module 801, the obstacle point coordinate calculation module 802, the environmental coordinate calculation module 803, and the scan matching module 804.

FIG. 9 is a block diagram illustrating a device 900 for obtaining localization information according to an exemplary embodiment. For example, the device 900 may be a mobile phone, a computer, a digital broadcasting terminal, a messaging device, a gaming console, a tablet, a medical device, exercise equipment, a personal digital assistant or the like.

Referring to FIG. 9, the device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls overall operations of the device 900, such as the operations associated with display, telephone calls, data communications, camera operations and recording operations. The processing component 902 may include one or more processors 920 to execute instructions to perform all or part of the steps in the abovementioned methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the device 900. Examples of such data include instructions for any application or method operated on the device 900, contact data, phonebook data, messages, pictures, videos, etc. The memory 904 may be implemented by any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the device 900. The power component 906 may include a power management system, one or more power sources, and any other components associated with generation, management and distribution of power for the device 900.

The multimedia component 908 includes a screen providing an output interface between the device 900 and a user. In some embodiments of the disclosure, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and pressure associated with the touch or swipe action. In some embodiments of the disclosure, the multimedia component 908 includes a front camera and/or a rear camera. The front camera and/or the rear camera may receive external multimedia data when the device 900 is in an operation mode, such as a photographing mode or a video mode. Each of the front camera and the rear camera may be a fixed optical lens system or have focusing and optical zooming capability.

The audio component 910 is configured to output and/or input audio signals. For example, the audio component 910 includes a microphone (MIC) configured to receive an external audio signal when the device 900 is in an operation mode, such as a call mode, a recording mode, and a voice recognition mode. The received audio signal may be further stored in the memory 904 or transmitted via the communication component 916. In some embodiments of the disclosure, the audio component 910 further includes a speaker to output audio signals.

The I/O interface 912 provides an interface between the processing component 902 and peripheral interface modules, and the peripheral interface module may be a keyboard, a click wheel, buttons, and the like. The button may include, but are not limited to, a home button, a volume button, a starting button, and a locking button.

The sensor component 914 includes one or more sensors to provide status assessments of various aspects of the device 900. For instance, the sensor component 914 may detect an on/off status of the device 900 and relative positioning of components, such as a display and small keyboard of the device 900, and the sensor component 914 may further detect a change in a position of the device 900 or a component of the device 900, presence or absence of contact between the user and the device 900, orientation or acceleration/deceleration of the device 900 and a change in temperature of the device 900. The sensor component 914 may include a P-sensor configured to detect presence of an object nearby without any physical contact. The sensor component 914 may also include a light sensor, such as a Complementary Metal Oxide Semiconductor (CMOS) or Charge Coupled Device (CCD) image sensor, configured for use in an imaging application. In some embodiments, the sensor component 914 may also include an acceleration sensor, a gyroscope sensor, a magnetic sensor, a pressure sensor or a temperature sensor.

The communication component 916 is configured to facilitate wired or wireless communication between the device 900 and other equipment. The device 900 may access a communication-standard-based wireless network, such as a Wireless Fidelity (Wi-Fi) network, a 4th-Generation (4G) or 5th-Generation (5G) network or a combination thereof. In an exemplary embodiment, the communication component 916 receives a broadcast signal or broadcast associated information from an external broadcast management system through a broadcast channel. In an exemplary embodiment, the communication component 916 further includes a Near Field Communication (NFC) module to facilitate short-range communication. In an exemplary embodiment, the communication component 916 may be implemented based on a Radio Frequency Identification (RFID) technology, an Infrared Data Association (IrDA) technology, an Ultra-WideBand (UWB) technology, a Bluetooth (BT) technology or another technology.

In exemplary embodiments, the device 900 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to perform the above described methods.

In an exemplary embodiment, there is also provided a non-transitory computer-readable storage medium including an instruction, such as the memory 904 including an instruction, and the instruction may be executed by the processor 920 of the device 900 to implement the above described methods. For example, the non-transitory computer-readable storage medium may be a ROM, Random Access Memory (RAM), a Compact Disc Read-Only Memory (CD-ROM), a magnetic tape, a floppy disc, an optical data storage device and the like. Also for example, the method includes: obtaining image information and related information of the image information, wherein the related information includes a depth map, a point cloud map, relocation postures and a relocation variance after relocation; obtaining three-dimensional coordinates of spatial obstacle points based on the depth map; obtaining target postures and environmental three-dimensional coordinates corresponding to each of the target postures based on the relocation postures, the relocation variance and the point cloud map; scanning and matching the three-dimensional coordinates of the spatial obstacle points with the environmental three-dimensional coordinates to obtain matching result information; and obtaining localization information based on the relocation postures and the relocation variance when the matching result information satisfies a predetermined condition.

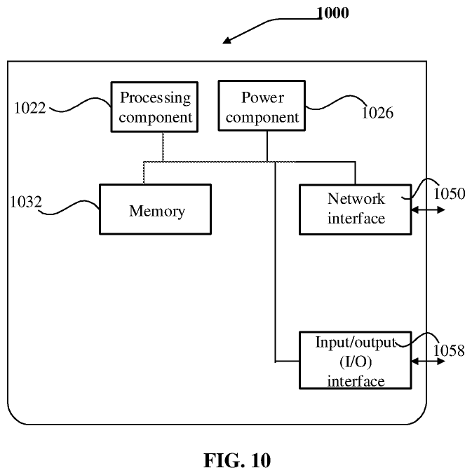

FIG. 10 is a block diagram illustrating a device 1000 for obtaining localization information according to an exemplary embodiment. For example, the device 1000 may be a server. Referring to FIG. 10, the device 1000 includes a processing component 1022, which further includes one or more processors and memory resource represented by a memory 1032 for storing instructions executable by the processing component 1022, such as an application program. The application program stored in the memory 1032 may include one or more modules, and each of those modules corresponds to a set of instructions. In addition, the processing component 1022 is configured to execute the instructions to implement the above method, which includes: obtaining image information and related information of the image information, wherein the related information includes a depth map, a point cloud map, relocation postures and a relocation variance after relocation; obtaining three-dimensional coordinates of spatial obstacle points based on the depth map; obtaining target postures and environmental three-dimensional coordinates corresponding to each of the target postures based on the relocation postures, the relocation variance and the point cloud map; scanning and matching the three-dimensional coordinates of the spatial obstacle points with the environmental three-dimensional coordinates to obtain matching result information; and obtaining localization information based on the relocation postures and the relocation variance when the matching result information satisfies a predetermined condition.

The device 1000 may also include a power component 1026 configured to perform power management of the device 1000, a wired or wireless network interface 1050 configured to connect the device 1000 to a network, and an input/output (I/O) interface 1058. The device 1000 may operate based on an operating system stored in the memory 1032, such as Windows Server™, Mac OS X™, Unix™, Linux™, FreeBSD™ or the like.

Other embodiments of the present disclosure will be apparent to those skilled in the art from consideration of the specification and practice of the present disclosure. The present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for obtaining localization information, comprising:
obtaining image information and related information of the image information, wherein the related information comprises: a depth map, a point cloud map, and relocation postures and a relocation variance after relocation;
obtaining three-dimensional coordinates of spatial obstacle points based on the depth map;
obtaining target postures and environmental three-dimensional coordinates corresponding to each of the target postures based on the relocation postures, the relocation variance, and the point cloud map;
scanning and matching the three-dimensional coordinates of the spatial obstacle points with the environmental three-dimensional coordinates to obtain matching result information; and
obtaining, when the matching result information satisfies a predetermined condition, localization information based on the relocation postures and the relocation variance.

2. The method according to claim 1, wherein obtaining target postures and environmental three-dimensional coordinates corresponding to each of the target postures based on the relocation postures, the relocation variance, and the point cloud map comprises:
obtaining a particle set based on the relocation postures and the relocation variance, wherein each particle in the particle set corresponds to one of the target postures; and
obtaining environmental three-dimensional coordinates of each particle based on the point cloud map, wherein the environmental three-dimensional coordinates corresponding to each of the target postures are environmental three-dimensional coordinates of the particle corresponding to the target posture.

3. The method according to claim 2, wherein obtaining the particle set based on the relocation postures and the relocation variance comprises:
obtaining a probability density of Gaussian probability distribution based on the relocation postures and the relocation variance; and
sampling the relocation postures to obtain the particle set according to the probability density of Gaussian probability distribution.

4. The method according to claim 2, wherein obtaining the environmental three-dimensional coordinates of each particle based on the point cloud map comprises:
obtaining the environmental three-dimensional coordinates of each particle by a ray casting algorithm based on the point cloud map.

5. The method according to claim 2, wherein scanning and matching the three-dimensional coordinates of the spatial obstacle points with the environmental three-dimensional coordinates to obtain the matching result information and obtaining localization information based on the relocation postures and the relocation variance when the matching result information satisfies a predetermined condition comprises:
obtaining a matching score of each particle by scanning and matching the three-dimensional coordinates of the spatial obstacle points with the environmental three-dimensional coordinates of each particle; and
determining, when a highest matching score is greater than a predetermined threshold, the relocation postures as a localization result.

6. The method according to claim 5, wherein obtaining the matching score of each particle by scanning and matching the three-dimensional coordinates of the spatial obstacle points with the environmental three-dimensional coordinates of each particle comprises:
scanning and matching the three-dimensional coordinates of the spatial obstacle points with the environmental three-dimensional coordinates of each particle by using a likelihood field model.

7. A device for obtaining localization information, comprising:
a processor; and
a memory for storing instructions executable by the processor;
wherein the processor is configured to:
obtain image information and related information of the image information, wherein the related information comprises: a depth map, a point cloud map, and relocation postures and a relocation variance after relocation;
obtain three-dimensional coordinates of spatial obstacle points based on the depth map;
obtain target postures and environmental three-dimensional coordinates corresponding to each of the target postures based on the relocation postures, the relocation variance, and the point cloud map;
scan and match the three-dimensional coordinates of the spatial obstacle points with the environmental three-dimensional coordinates to obtain matching result information, and obtain localization information based on the relocation postures and the relocation variance when the matching result information satisfies a predetermined condition.

8. The device according to claim 7, wherein the processor is further configured to:
obtain a particle set based on the relocation postures and the relocation variance, wherein each particle in the particle set corresponds to one of the target postures; and
obtain environmental three-dimensional coordinates of each particle based on the point cloud map, wherein the environmental three-dimensional coordinates corresponding to each of the target postures are environmental three-dimensional coordinates of the particle corresponding to the target posture.

9. The device according to claim 8, wherein the processor is further configured to:
obtain a probability density of Gaussian probability distribution based on the relocation postures and the relocation variance;
sample the relocation postures to obtain the particle set according to the probability density of Gaussian probability distribution; and
obtain the environmental three-dimensional coordinates of each particle by a ray casting algorithm based on the point cloud map.

10. The device according to claim 8, wherein the processor is further configured to:
obtain a matching score of each particle by scanning and matching the three-dimensional coordinates of the spatial obstacle points with the environmental three-dimensional coordinates of each particle; and
determine, when the highest matching score is greater than a predetermined threshold, the relocation postures as a localization result.

11. The device according to claim 10, wherein the processor is further configured to:
scan and match the three-dimensional coordinates of the spatial obstacle points with the environmental three-dimensional coordinates of each particle by using a likelihood field model.

12. A non-transitory computer-readable storage medium having stored thereon instructions that, when executed by a processor of a terminal, cause the terminal to implement a method for obtaining localization information, the method comprising:
obtaining image information and related information of the image information, wherein the related information comprises: a depth map, a point cloud map, and relocation postures and relocation variance after relocation;
obtaining three-dimensional coordinates of spatial obstacle points based on the depth map;
obtaining target postures and environmental three-dimensional coordinates corresponding to each of the target postures based on the relocation postures, the relocation variance, and the point cloud map;
scanning and matching the three-dimensional coordinates of the spatial obstacle points with the environmental three-dimensional coordinates to obtain matching result information; and
obtaining localization information based on the relocation postures and the relocation variance when the matching result information satisfies a predetermined condition.

13. The non-transitory computer-readable storage medium according to claim 12, wherein obtaining target postures and environmental three-dimensional coordinates corresponding to each of the target postures based on the relocation postures, the relocation variance and the point cloud map comprises:
obtaining a particle set based on the relocation postures and the relocation variance, wherein each particle in the particle set corresponds to one of the target postures; and
obtaining environmental three-dimensional coordinates of each particle based on the point cloud map, wherein the environmental three-dimensional coordinates corresponding to each of the target postures are environmental three-dimensional coordinates of the particle corresponding to the target posture.

14. The non-transitory computer-readable storage medium according to claim 13, wherein obtaining the particle set based on the relocation postures and the relocation variance comprises:
obtaining a probability density of Gaussian probability distribution based on the relocation postures and the relocation variance; and
sampling the relocation postures to obtain the particle set according to the probability density of Gaussian probability distribution.

15. The non-transitory computer-readable storage medium according to claim 13, wherein obtaining the environmental three-dimensional coordinates of each particle based on the point cloud map comprises:
obtaining the environmental three-dimensional coordinates of each particle by a ray casting algorithm based on the point cloud map.

16. The non-transitory computer-readable storage medium according to claim 13, wherein scanning and matching the three-dimensional coordinates of the spatial obstacle points with the environmental three-dimensional coordinates to obtain the matching result information and obtaining localization information based on the relocation postures and the relocation variance when the matching result information satisfies a predetermined condition comprise:
obtaining a matching score of each particle by scanning and matching the three-dimensional coordinates of the spatial obstacle points with the environmental three-dimensional coordinates of each particle; and
determining, when a highest matching score is greater than a predetermined threshold, the relocation postures as a localization result.

17. The non-transitory computer-readable storage medium according to claim 16, wherein obtaining the matching score of each particle by scanning and matching the three-dimensional coordinates of the spatial obstacle points with the environmental three-dimensional coordinates of each particle comprises:
scanning and matching the three-dimensional coordinates of the spatial obstacle points with the environmental three-dimensional coordinates of each particle by using a likelihood field model.
